(19) United States
(12) Patent Application Publication
(10) Pub. No.: US 2006/0181542 A1
(43) Pub. Date: Aug. 17, 2006

(54) Equivalent primary display

(76) Inventor: Edward M. Granger, Novato, CA (US)

Correspondence Address: GREENBERG TRAURIG LLP, 2450 COLORADO AVENUE, SUITE 400E, SANTA MONICA, CA, 90404, US

(21) Appl. No.: 11/354,421

(22) Filed: Feb. 14, 2006

Related U.S. Application Data
(60) Provisional application No. 60/653,151, filed on Feb. 15, 2005.

(51) Int. Cl. G09G 5/02

(52) U.S. Cl. 345/589

(57) ABSTRACT

A method and system for driving an LED based projector in which each of the LED banks is excited during a single duty cycle of a frame time rather than sequentially. This method powers multiple LED banks at least partially simultaneously producing an equivalent HDTV Primary color and thereby a brighter optimized display. The method of driving a projector using red, green, and blue light emitting diodes (LEDs) includes determining an equivalent primary display (EPD) chromaticity for each primary color in a frame time; and timing excitation of each of the red, green, and blue LEDs in a same duty cycle of a frame time in accordance with the equivalent primary display chromaticity determined.

### RELATED APPLICATION

This application claims the benefit of and priority to U.S. Provisional Application Ser. No. 60/653,151, entitled EQUIVALENT PRIMARY LED DISPLAY DRIVER, filed on Feb. 15, 2005, the contents of which are incorporated by reference herein in its entirety.

### BACKGROUND

1. Field

This disclosure relates to light emitting diode (LED) projection display systems and more particularly to a system and method for driving a LED projector device for use in such displays.

2. General Background

The International Commission on Illumination (CIE) created a mathematically defined color space known as the CIE XYZ color Space in 1931. This CIE 1931 color space was derived from experimental results in the 1920s. Visual displays today, such as computer monitors and television displays, are typically comprised of a matrix of pixels in a two dimensional plane. These displays produce a color image typically based on each pixel comprising three additive light primaries: red, green and blue, collectively denoted RGB, and are based on a subset within the CIE color space.

The human eye has three types of color sensors that respond to different ranges of light wavelengths. The concept of color can be thought of as having two parts: chromaticity and brightness. In the CIE XYZ color space, the Y parameter is a measure of the brightness of a color. The chromaticity of a color is specified by two derived parameters x and y, which are functions of three tristimulus values X, Y, and Z.

In a conventional LED display projection system there are green, blue, and red LEDs, each producing their characteristic blue, green, and red light at specific intensities, each excited in sequence to generate the required resultant color in a sequential pattern. This pattern is red, then green then blue, in order to blend the three into the desired hue and intensity for a particular pixel as perceived by a viewer. This pattern is typically in a ratio of 6:3:2 in terms of intensity.

### SUMMARY

The LED display projector driving method in accordance with the present disclosure does not involve sequential illumination of the LEDs as is done in driving conventional LED displays. Instead, within each pixel frame time each of the LED sets are excited in order to achieve the color hue and intensity level desired. Thus during the blue pixel duty cycle in each frame time, while the blue LEDs are excited, the red and green LEDs are also excited for an appropriate lesser amount of time to achieve the requisite pixel chromaticity values for the desired hue and intensity perceived by the viewer. This new methodology maximizes the total lumens of light that can be projected onto the projection screen. In addition, the blending of simultaneous LED illumination times within each pixel duty cycle in each frame time substantially minimizes any perceived color wheel, or rainbow spectrum effect by the viewer.

A system for driving an LED display projector comprises an input signal, an equivalent primary display driver powering a combination of at least two different color LEDs in the projector during each red display frame and each green display frame. More preferably, an LED display projection system in accordance with the present disclosure can take any input signal, from any source, run it through the equivalent primary display transforms in accordance with the present disclosure, and feed the equivalent transforms to the LED projection device to achieve enhanced brightness while consuming less energy in the process.

### DRAWINGS

The above-mentioned features and objects of the present disclosure will become more apparent with reference to the following description taken in conjunction with the accompanying drawings wherein like reference numerals denote like elements and in which:

FIG. 1 is a graph showing equivalent primary colors red, green and blue in accordance with the present disclosure superimposed on a CIE 1931 chromaticity diagram along with standard red, green and blue endpoint values from the 709 HDTV standard.

FIG. 2 is a block diagram of an LED projection device being driven in accordance with the equivalent primary display method of the present disclosure.

### DETAILED DESCRIPTION

The Equivalent Primary Display (EPD) method in this present disclosure is a method of driving an LED based micro display projector in which a plurality of the red, green and blue LED banks are simultaneously driven within each duty cycle in each frame time rather than each bank being powered sequentially. This method has two advantages. First, the micro display does not require the HDTV RGB signals to be processed by a matrix. Second, the EPD method powers multiple LED banks to produce the equivalent HDTV primary and therefore will produce a brighter display.

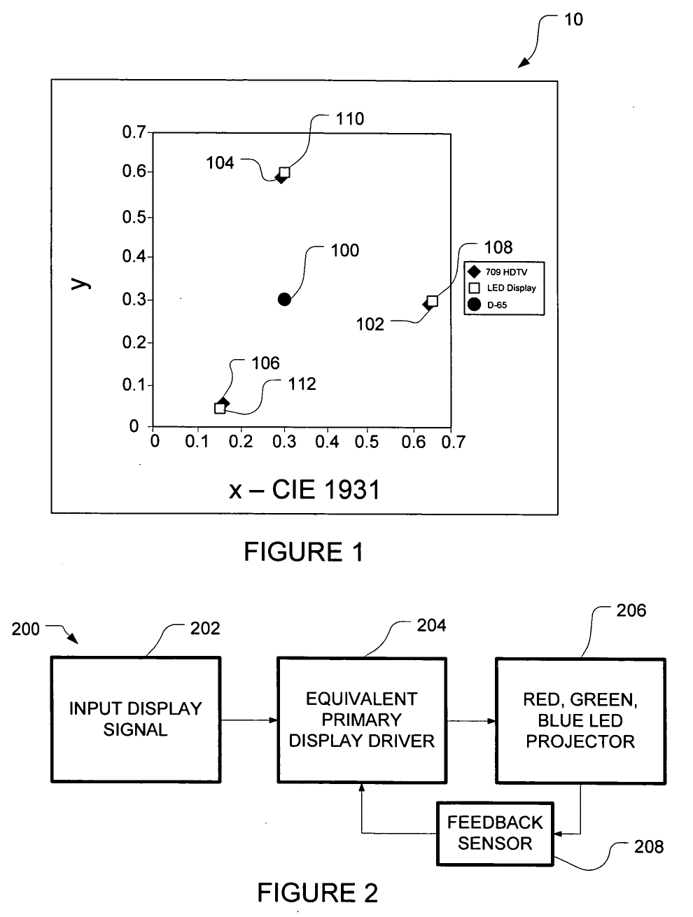

The preferred system in accordance with the disclosure powers the red and green LEDs during the red and green display frame times and only the blue LED during the blue display frame time. The combination of the diodes being driven with the proper timing sequence produces a set of equivalent primaries that closely approximate the HDTV RGB primaries. The proposed new primary set is shown on FIG. 1.

FIG. 1 is a CIE 1931 color space chromaticity diagram without the full chromaticity spectrum being shown. This CIE 1931 color space chromaticity diagram is a two dimensional diagram wherein the “x”-axis and the “y”-axis are derived values from

$$x = \frac{X}{X + Y + Z} , y = \frac{Y}{X + Y + Z} .$$

The X and Z are tristimulus values that can be calculated back from the chromaticity values x and y and the Y tristimulus value:

$$X = \frac{Y}{y} y , Z = \frac{Y}{y} ( 1 - x - y ) .$$

The center dot 100 in FIG. 1 represents a pure white light which is an approximate 3:6:2 part mixture of the red, green and blue light from the LEDs, and thus the color white as perceived by a viewer, is exemplified by standard white point D-65. The three diamond values 102, 104, and 106, represent the conventional ITU 709 HDTV Production Standard values for red, blue and green chromaticities superimposed on the x-y plot of FIG. 1.

The squares 108, 110, and 112 represent the red, green and blue chromaticity color point values for an LED based projection engine driven in accordance with the EPD method of the present disclosure.

The graph in FIG. 1 shows that there is little calorimetric compromise in the new option of producing an equivalent matrix by turning on more than one set of LEDs during the same duty cycle in each frame time. In fact, we can get an exact match. In FIG. 1, however, a simplified set of equivalents was utilized that does not require illumination of the blue LED at all at the red and green points since the match was very close. There is also a possibility that with proper choice of the timing sequence, as explained below, that the color flicker artifact, or color wheel effect, can be reduced. The matrix form of the EPD conversions is shown in the next section.

FIG. 2 shows a simplified schematic of an LED display projection system 200 in which any input signal 202 is transformed in the equivalent primary display driver 204 and then fed into the RGB LED projector 206. This arrangement maximizes the output of the projector 206, and hence the viewer perceived display brightness.

The EPD Matrix

The development of the new method starts with the chromaticity coordinates of the LEDs. The chromaticity coordinates for a typical current LED selection are:

| | Chromaticity Coordinates | | |
|---|---|---|---|
| | Red | Green | Blue |
| x | 0.687 | 0.139 | 0.14 |
| y | 0.313 | 0.742 | 0.041 |
| z | 0 | 0.119 | 0.819 |

The columns of this matrix can be scaled so that the RGB tristimulus contributions add together to produce a white point that has unit luminance and given chromaticity coordinates. The HDTV standard white point is defined to be D-65. The rescaled matrix becomes:

Scaled contributions

| Tristimulus | Red | Green | Blue |
|---|---|---|---|
| X | 0.660355 | 0.12175 | 0.168077 |
| Y | 0.30086 | 0.649917 | 0.049223 |
| Z | 0 | 0.104232 | 0.983253 |

The row sums of this matrix yield the tristimulus values of the D-65 illuminate, element 100, in FIG. 1, X_{W}=0.9502, Y_{W}=1.0 and Z_{W}=1.088.

Next, the color space of the Rec. ITU-R BT.709-4 HDTV standard defines the chromaticity coordinates of the HDTV primaries as:

| | Chromaticity Coordinates | | |
|---|---|---|---|
| | Red | Green | Blue |
| x | 0.64 | 0.3 | 0.15 |
| y | 0.33 | 0.6 | 0.06 |
| z | 0.03 | 0.1 | 0.79 |

These red, green, and blue coordinates are shown as points 102, 104, and 106 respectively in FIG. 1. Just as in the case of the LEDs, the columns of this matrix are scaled to produce a D-65 white point. The scaled matrix for the HDTV primaries has a tristimulus matrix:

Scaled contributions

| Tristimulus | Red | Green | Blue |
|---|---|---|---|
| X | 0.412348 | 0.357656 | 0.180178 |
| Y | 0.212617 | 0.715312 | 0.072071 |
| Z | 0.019329 | 0.119219 | 0.948937 |

Now we define a short hand notation to represent the two tristimulus matrices. Denote the LED matrix, as T_{L} and the HDTV matrix, as T_{H}.

The relationship between the primaries and the resulting luminous output are:

$$[ \begin{matrix}{X}_{L} \\ {Y}_{L} \\ {Z}_{L}\end{matrix} ] = {T}_{L} * [ \begin{matrix}{R}_{L} \\ {G}_{L} \\ {B}_{L}\end{matrix} ]$$

$$and \\ [ \begin{matrix}{X}_{H} \\ {Y}_{H} \\ {Z}_{H}\end{matrix} ] = {T}_{H} * [ \begin{matrix}{R}_{H} \\ {G}_{H} \\ {B}_{H}\end{matrix} ]$$

And the matrix that converts the HDTV RGB digital values to the LED drive digital values is:

$$[ \begin{matrix}{R}_{L} \\ {G}_{L} \\ {B}_{L}\end{matrix} ] = {T}_{L}^{- 1} * {T}_{H} * [ \begin{matrix}{R}_{H} \\ {G}_{H} \\ {B}_{H}\end{matrix} ]$$

Solving for T_{L}⁻¹*T_{H}, the conversion matrix is:

| | | |
|---|---|---|
| 0.612768 | 0.36434 | 0.0228913 |
| 0.042333 | 0.930245 | 0.0274226 |
| 0.01517 | 0.022636 | 0.9621931 |

Note that many of the off diagonal elements are small and can be set to zero. As mentioned above, and as shown in FIG. 1, the conversion matrix can be approximated by the following matrix. However, an exact match can be made utilizing the above precise conversion matrix:

| | | |
|---|---|---|
| 0.63 | 0.37 | 0 |
| 0.05 | 0.95 | 0 |
| 0 | 0 | 1 |

This simplified conversion matrix was used to produce the EPD chromaticity coordinates 108, 110, and 112 respectively shown on FIG. 1. The matrix shows that the equivalent HDTV Red primary point 108 is made up of 63 percent of the Red LED primary and 5 percent of the Green LED primary, the equivalent HDTV Green primary point 110 is made up of 37 percent of the Red LED primary and 95 percent of the Green LED primary and the equivalent HDTV Blue primary point 112 is equal to the LED Blue primary. The tristimulus contributions of the equivalent Red primary point 108 are:

| LED | Red | Green | Blue |
|---|---|---|---|
| X | 0.416024 | 0.006087 | 0 |
| Y | 0.189542 | 0.032496 | 0 |
| Z | 0 | 0.005212 | 0 |

for the equivalent Green primary point 110 they are;

| LED | Red | Green | Blue |
|---|---|---|---|
| X | 0.244331 | 0.1156624 | 0 |
| Y | 0.111318 | 0.6174211 | 0 |
| Z | 0 | 0.0990204 | 0 |

and for the equivalent Blue primary point 112 they are;

| LED | Red | Green | Blue |
|---|---|---|---|
| X | 0 | 0 | 0.168077 |
| Y | 0 | 0 | 0.049223 |
| Z | 0 | 0 | 0.983253 |

The tristimulus contributions for each LED have been determined for each of the equivalent primaries. The final stage is to determine the time each primary will be turned on given the lumen output of each LED. The next section of this specification shows how the timing of the LED driver 204 is derived to produce the maximum luminous output from the projector 206.

Optimum Timing for EPD

A very significant step in obtaining a maximum brightness in a given LED projection system is scaling the matrices in an appropriate manner. The equivalent primary tristimulus matrices given above are scaled to have a luminosity of 1.0 when all the components of the equivalent primaries are added to produce a D-65 white. This ensures that the maximum brightness is achieved. The Red, Green, and Blue equivalent primaries points 108, 110, and 112 each have a major luminance contributor. It is no surprise that the major contribution to luminance for the Red equivalent primary is the red LED. The same is true for the green and blue LEDs for the other primaries. The luminance tristimulus values for the LEDs are _{R}Y_{R}=0.1895, _{G}Y_{G}=0.6174 and _{B}Y_{B}=0.0492 for the Red, Green and Blue LEDs respectively.

Let us assume that the maximum lumen output of the of the Red, Green, and Blue LEDs is Lᵣ, L_{g}, and L_{b} respectively. The luminous output of the final image then is the sum of the maximum output for each LED times the amount of time each LED is on. The contributions can be calculated;
Lᵣ*Tᵣ=_{R}Y_{R}*L
L_{g}*T_{g}=_{G}Y_{G}*L
L_{b}*T_{b}=_{B}Y_{B}*L
where Tᵣ, T_{g}, and T_{b} are the amounts of time the Red, Green, and Blue LEDs are turned on and L is the total luminous output of the projector 200 for the fundamental LED primaries.

The final restraint on the system is;
Tᵣ+T_{g}+T_{b}=1

This yields the relative amounts of time each LED is on during a frame time. This restraint is necessary to solve for Tᵣ, T_{g}, T_{b}, and L.

The solution to this set of equations is:
C=L_{g}*L_{b}*_{R}Y_{R+L}ᵣ*L_{b}*_{G}Y_{G}+Lᵣ*L_{g}*_{B}Y_{B}

C is defined to simplify the following expressions.

The relative on times for each LED are as follows:

For the Red LED;
Tᵣ=(L_{g}*L_{b}*_{R}Y_{R})/C

For the Green LED;
T_{g}=(Lᵣ*L_{b}*_{G}Y_{G})/C

For the Blue LED;
T_{b}=(Lᵣ*L_{g}*_{B}Y_{B})/C

And finally the total luminous output of the Red, Green, and Blue LEDs is;
L=(Lᵣ*L_{g}*L_{b})/C

When the other equivalent primary luminance contributions are added, the final luminous output of the projector is:
L_{Total}=1.168*L

The timing for the Green LED required to produce the Red equivalent primary is determined by:

$${}_{r}^{}{T}{}_{g}^{} = \frac{{}_{R}^{}{Y}{}_{G}^{} * {L}_{Total}}{{L}_{g}}$$

where _{R}Y_{G} is the tristimulus value of the Green sub primary for the equivalent Red primary.

The timing for the Red LED required to produce the Green equivalent primary is determined by:

$${}_{g}^{}{T}{}_{r}^{} = \frac{{}_{G}^{}{Y}{}_{R}^{} * {L}_{Total}}{{L}_{r}}$$

where _{G}Y_{R} is the tristimulus value of the Red sub primary for the equivalent Green primary.

The EPD method of illuminating an LED projector 206 has the advantage of using the LED output for the maximum amount of time. The ability to have more than one LED on at the time adds to the final output brightness. The EPD method also eliminates a matrix computation for each pixel in the display. The EPD projector 206 can easily change color temperature and display primaries by adjusting the timing of the equivalent primary contributions. This method also would be of advantage in the case that the manufacturer could not produce a bright red LED. The output of the red LED is split between the Red and Green equivalent primaries making the brightness of the red LED less critical.

The EPD method also offers the possibility of reducing color flicker by delaying the sub primaries in the timing process. The amount of optimal delay for each sub primary would have to be empirically determined. Chroma flicker can thus be minimized by selective timing duration of power application to each of the red, green and blue LEDs during each display frame sequence. This delay may be either manually adjusted via display panel controls or could be automatically controlled via an RGB feedback sensor 208 sensing at least one of the powered LED's parameters such as brightness and providing a feedback signal to the driver 206 to maintain and control both display brightness and white point color temperature.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of driving a projector using red, green, and blue light emitting diodes (LEDs) comprising:
determining an equivalent primary display (EPD) chromaticity for each primary color in a frame time; and
timing excitation of each of the red, green, and blue LEDs in a same duty cycle of a frame time in accordance with the equivalent primary display chromaticity.

2. The method according to claim 1 wherein the EPD chromaticity for each primary color is determined by determining tristimulus contributions for each LED.

3. The method according to claim 2 wherein the equivalent tristimulus contributions of the equivalent red primary are approximately:

| LED | Red | Green | Blue |
|---|---|---|---|
| X | 0.416024 | 0.006087 | 0 |
| Y | 0.189542 | 0.032496 | 0 |
| Z | 0 | 0.005212 | 0 |

4. The method according to claim 2 wherein the equivalent tristimulus contributions of the equivalent green primary are approximately:

| LED | Red | Green | Blue |
|---|---|---|---|
| X | 0.244331 | 0.1156624 | 0 |
| Y | 0.111318 | 0.6174211 | 0 |
| Z | 0 | 0.0990204 | 0 |

5. The method according to claim 2 wherein the equivalent tristimulus contributions of the equivalent blue primary are approximately:

| LED | Red | Green | Blue |
|---|---|---|---|
| X | 0 | 0 | 0.168077 |
| Y | 0 | 0 | 0.049223 |
| Z | 0 | 0 | 0.983253 |

6. The method according to claim 2 wherein the equivalent tristimulus contributions of the equivalent red primary are approximately:

| LED | Red | Green | Blue |
|---|---|---|---|
| X | 0.416024 | 0.006087 | 0 |
| Y | 0.189542 | 0.032496 | 0 |
| Z | 0 | 0.005212 | 0 |

the equivalent tristimulus contributions of the equivalent green primary are approximately;

| LED | Red | Green | Blue |
|---|---|---|---|
| X | 0.244331 | 0.1156624 | 0 |
| Y | 0.111318 | 0.6174211 | 0 |
| Z | 0 | 0.0990204 | 0 |

and the equivalent tristimulus contributions of the equivalent blue primary are approximately;

| LED | Red | Green | Blue |
|---|---|---|---|
| X | 0 | 0 | 0.168077 |
| Y | 0 | 0 | 0.049223 |
| Z | 0 | 0 | 0.983253 |

7. The method according to claim 1 wherein the timing of the Red, Green, and Blue LEDs is determined by:
determinging the luminance tristimulus values for the LEDs; and
determining the maximum lumen output L of each of the red, green, and blue LEDs Lᵣ L_{g} and R_{b};
setting the sum of the relative times each of the LEDs is on equal to unity; and
determining the relative on time during a frame according to the following equation for the RED LED: Tᵣ=(L_{g}*L_{b}*_{R}Y_{R})/C; for the Green LED: T_{g}=(Lᵣ*L_{b}*_{G}Y_{G}) /C; and for the Blue LED: T_{b}=(Lᵣ* L_{g}*_{B}Y_{B})
where C=L_{g}*L_{b}*_{R}Y_{R}+Lᵣ*L_{b}*_{G}Y_{G}+Lᵣ*L_{g}*_{B}Y_{B}

8. The method of claim 1 further comprising sensing a characteristic of each LED while powered to maintain display brightness and white point color temperature.

9. A system for driving an LED display projector comprising:
an input signal;
an equivalent primary display driver powering a combination of at least two different color LEDs in the projector during each red display frame and each green display frame.

10. The system according to claim 9 wherein at least a blue LED is powered during a blue display frame.

11. The system according to claim 9 wherein only the red and green LEDs are powered during the red and green display frame sequences.

12. The system according to claim 11 wherein a blue LED is powered only during a blue display frame sequence.

13. The system according to claim 9 wherein each of the red, green, and blue LEDs are powered during each of the red, green, and blue display frame sequences.

14. The system according to claim 13 wherein chroma flicker is minimized by selective timing duration of power application to each of the red, green, and blue LEDs during each display frame sequence.
